(19) United States
(12) Patent Application Publication
(10) Pub. No.: US 2007/0229947 A1
(43) Pub. Date: Oct. 4, 2007

(54) Projection Screen Control Apparatus

(76) Inventor: Phillip Tuttobene, Orlando, FL (US)

Correspondence Address: KEN BURRASTON;KIRTON & MCCONKIE, PO BOX 45120, SALT LAKE CITY, UT, 84145-0120, US

(21) Appl. No.: 11/278,505

(22) Filed: Apr. 3, 2006

(51) Int. Cl. G03B 21/56

(52) U.S. Cl. 359/443

(57) ABSTRACT

Systems and methods for automatically controlling electrical devices including a system and method for automatically controlling a retractable projection screen based on the sensed electrical state of an associated projection device.

### BACKGROUND

Audiovisual presentations often rely upon a projection device to create a visual image. While some projection devices capable of creating a visual image comprise a means of displaying the image, such as is found in a standard cathode-ray-based television set, a growing number of projection devices rely on a separate device comprising a high-quality surface onto which a visual image can be displayed—a projection screen. Projection screens have long been used in commercial establishments such as movie theaters, but they are also becoming more prevalent each year in businesses and homes as higher quality audiovisual equipment—including DVD and other digital and high-definition video devices—make the quality of the projection screen more important to the overall viewing experience.

A simple painted wall or other surface can function as a viewing surface onto which a device can project a visual image. Nevertheless, specially designed projection screens are widely used, as they provide a better viewing experience by providing higher reflectivity, sharpness, and other characteristics for the viewer.

In many circumstances, a projection screen is not used continuously. In these circumstances, it may be advantageous to use a projection screen that can be easily placed in service temporarily during use. Flexible projection screens constructed of fabric, resilient plastics, and many other materials, are often used for this purpose. These and similar projection screens are referred to generally as retractable projection screens, because of their ability to retract into a hidden area or roll up into a small cylinder when not in use. Fixed projection screens may also be placed in use by relying upon moveable panels or similar devices capable of hiding or revealing the projection screen.

Prior art devices suffer from certain disadvantages. Any device or control means that is wired to the motor of a retractable projection screen or moveable panels greatly increases the costs of installation compared to simply mounting the screen itself; such devices may also be prone to costly repairs because portions of the device or its control structures may be hidden behind walls, cabinetry, or otherwise inaccessible. Conversely, the use of a wireless manual remote control suffers from the inconvenience of the user maintaining an additional remote control device, which may be lost, misplaced, or forgotten. In some cases, the projection device may have already started to project an image without the projection screen being placed in service, causing annoying delays F and the need to replay—when replay is even possible—missed portions of an audiovisual presentation.

### SUMMARY

The present invention relates to systems and methods for automatically controlling electrical devices. More particularly, some embodiments of the present invention relate to a system and method for automatically controlling access to a retractable projection screen based on the state of an associated projection device

### DESCRIPTION OF THE FIGURES

FIG. 1 illustrates a system constructed according to the present invention.

FIG. 2A illustrates a power cord constructed according to one embodiment of a portion of the present invention.

FIG. 2B illustrates a power cord constructed according to one embodiment of a portion of the present invention.

FIG. 2C illustrates a cross sectional view of the components comprising a power cord constructed according to one embodiment of a portion of the present invention.

FIG. 3 illustrates one embodiment of the present invention used with a projection device and retractable projection screen.

FIG. 3A illustrates one component of an embodiment of the present invention that uses a projection screen associated with moveable panels.

FIG. 4 illustrates one embodiment of the present invention in which sensor and transmitter are constructed as a distinct component.

FIG. 5 illustrates one embodiment of the present invention in which the sensor comprises a light-sensitive device.

### DETAILED DESCRIPTION OF EXEMPLARY EMBODIMENTS

This specification describes exemplary embodiments and applications of the invention. The invention, however, is not limited to these exemplary embodiments and applications or to the manner in which the exemplary embodiments and applications operate or are described herein. Moreover, the Figures may show simplified or partial views, and the dimensions of elements in the Figures may be exaggerated or otherwise not in proportion for ease of illustration and clarity.

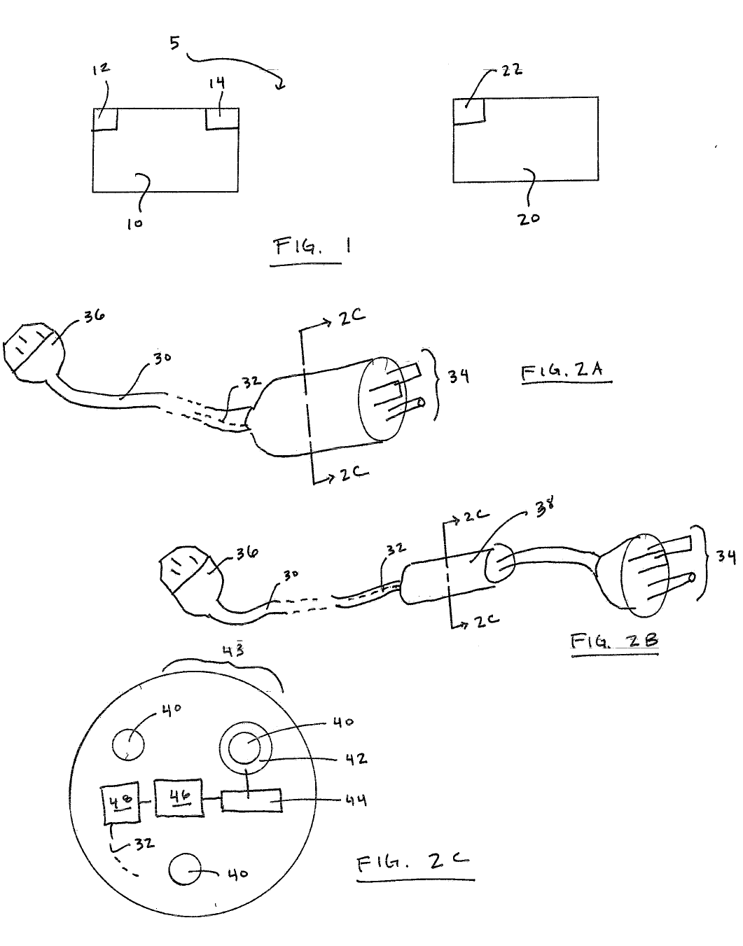

FIG. 1 illustrates a system 5 according to some embodiments of the present invention, the system 5 having a first electrical device capable of transmitting a signal and a second electrical device capable of receiving a signal. In some aspects, the system 5 comprises a sensor 12 configured to sense the state of a first electrical device 10, where the first electrical device is electrically coupled to a transmitter 14; also a receiver 22, which is configured to control or activate a second electrical device 20. In some aspects, the actions or state of the second electrical device 20 are also governed by the state of the first electrical device 10, as determined by the sensor 12. These and other aspects are discussed more fully herein.

The sensor 12 may comprise any device capable of detecting the state of an electrical device, including without limitation a state such as whether the device is on, off, in start-up mode, non-functional, or otherwise, as determined by the characteristics and capacities of a particular electrical device. In some embodiments, the sensor 12 is an electrical component or combination of electrical components that sense whether an electrical device is turned on or activated. In some embodiments, the sensor 12 is a light-sensitive device that senses whether a light is emitted from an electrical device.

In some aspects, sensor 12 may comprise electrical components capable of sensing the presence of an electrical current or a voltage. Such a sensor 12 may determine whether an electrical device is activated or turned on by sensing whether that device draws current from a current source, or whether the voltage across two electrical contact points changes over time.

According to some embodiments of the invention, a transmitter 14 may be any device capable of communicating a signal, as is well known in the art, including communicating in a digital or analog fashion, using wired or wireless means, including, as non-limiting examples, infrared, radio frequency, microwave, and similar communication methods.

Corresponding to the transmitter is a receiver 22 configured to receive communications originating at the transmitter 14. Based on the method used by the transmitter 14, the receiver 22 may also be of any design known in the art, including, without limitation, digital, analog, wired, wireless, infrared, radio frequency, and microwave means of communication.

According to some embodiments of the invention, multiple transmitters may be configured to communicate with a single receiver; these multiple transmitters may either correspond to multiple, distinct electrical devices or to a single electrical device to which multiple sensors have been associated, each with an independent transmitter. Further, multiple transmitters may be configured to communicate with multiple receivers in a many-to-many arrangement by which, if t any one or many of a selected group of electrical devices are sensed to be in a particular state, transmitters may communicate with one or more receivers to cause respective actions in one or more secondary devices. Still further, in some embodiments, one transmitter may be configured to communicate with multiple receivers, as when one device interacts with a variety of corresponding devices. Such a configuration may make use of distinct signals to identify devices individually or by grouping, according to digital parameters, selected transmission frequencies, or using any other parameter.

The second electrical device 20 to which one or more receivers 22 is couple may be any device capable of altering its activity or configuration based on the status communicated via receiver 22. According to some embodiments of the invention, the second electrical device 20 comprises an automatic electrically retractable projection screen that is able to retract or extend based on information received through a receiver 22. In other embodiments, the second electrical device 20 comprises coverings that are electrically moveable to disclose a projection screen that may be fixed or moveable.

According to some embodiments of the invention, as shown generally in FIG. 3, sensor 12, shown in the embodiment as sensor 43, is configured to sense the state of a first electrical device 10, such as a video projector 50. Various sensors may sense states that include On, Off, Warm-up, Shutting down, or otherwise. The sensor 12 attached to a first electrical device 10 may be configured to interact with the electrical connection by which that device draws AC power from power receptacle 52, as shown in FIGS. 2A, 2B, and 2C, in which sensor circuitry 44 determines whether current is being drawn by projector 50. In this manner, sensor 43 can determine when projector 50 has been turned on.

According to some embodiments of the invention, sensor 43 comprises a current transformer 42, current sense circuitry 44, and a switch 46, wherein switch 46 is installed in or adjacent to power receptacle 52 used by projector 50. Switch 46 can comprise a micro controller capable of detecting a change in voltage using current sense circuitry 44, as measured by the current transformer 42 or otherwise. Switch 46 can be programmed to turn on or off an RF transmitter 48, or to change the state of the signal emitted by RF transmitter 48, based upon the level of voltage change sensed or based upon other factors or parameters.

According to some embodiments of the invention, miniature circuitry comprising switch 46, current sense circuitry 44, current transformer 42, and RF transmitter 48, may be designed as part of power plug 34 similar to a standard power cord for a projection device, as shown in FIG. 2A; such miniature circuitry may also be designed as a separate component placed inline along the length of a power cord (see FIG. 2B) that provides power to a first electrical device 10. According to some embodiments of the invention, an antenna 32 is connected to RF transmitter 48 and extends along power cord 30. Wires or metal protrusions as typically comprise a power cord 30 or plug 34 can pass through holes 40, permitting direct sensing of changes in voltage using current transformer 42.

A power cord 30 constructed according to one embodiment of the invention can include a distal end 36 that connects to a first electrical device 10, as, for example, projector 50, such that when the first electrical device 10 is activated, current flows through hole 40 centered upon the current transformer 42, changing the transmission state of RF transmitter 48.

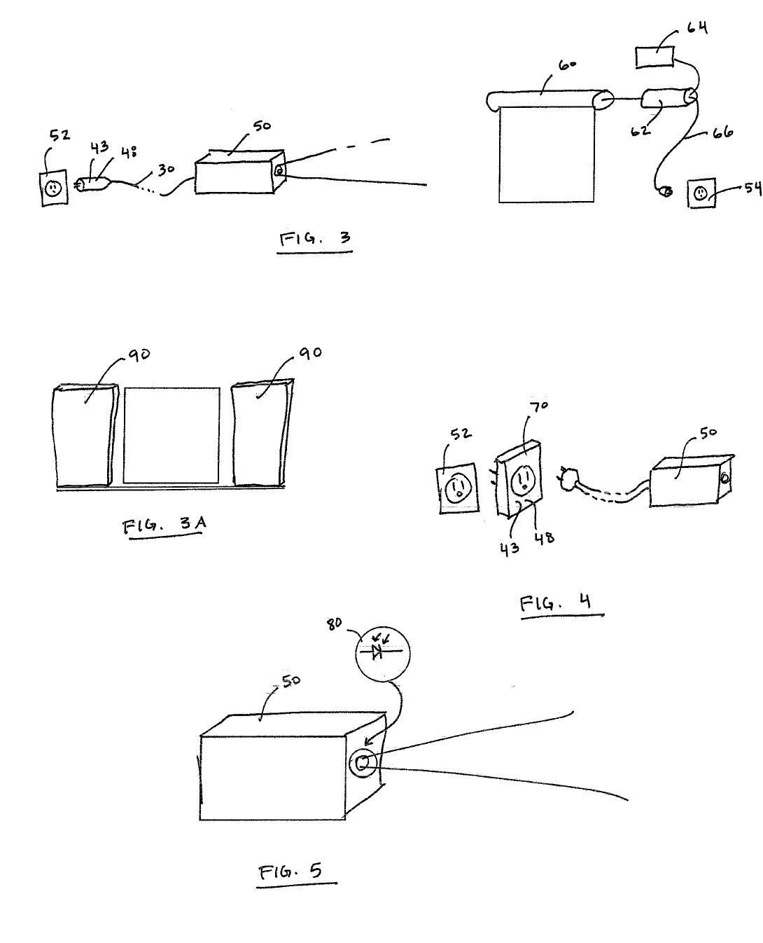

According to some embodiments of the invention, sensor 12 is placed within a first electrical device 10, such as within a projector 50; in other embodiments, as discussed above, the sensor is placed within or adjacent to power cord 30, so that power cord 30 itself or an additional component of power cord 30 can function as an antenna for a transmitter 14 coupled to a sensor 12. In still other embodiments, shown in FIG. 4, a sensor 12 and transmitter 14 can be constructed as a physically distinct component 70, where component 70 plugs into a power receptacle 52, and a first electrical device 10, such as a projector 50, can then plug into component 70. This permits an embodiment of the invention to be used with a first electrical device 10 that was not originally manufactured to comprise enabling components of the present invention. An embodiment that uses component 70 may also permit lower manufacturing costs and more convenience or flexibility where the ends of power cord 30 would be too large to be accommodated by existing electrical structures if they included all necessary components of an embodiment of the invention.

Sensor 12, as coupled to transmitter 14, may transmit in analog or digital fashion, and may transfer either a single indication of a change in the state of a first electrical device 10 or may transmit a continuous signal, for example, when the first electrical device 10 is on or when the first electrical device 10 is off.

According to some embodiments of the invention, as shown in FIG. 5, sensor 12 comprises a light-sensitive device 80 positioned so as to sense when the light source within a first electrical device 10, such as a projector 50, is lit.

According to some embodiments of the invention, transmitter 14 and receiver 22 comprise a standard radio-frequency transmitter/receiver pair, as is well known in the art. According to some embodiments of the invention, transmitter 14 is electrically coupled to sensor 12 located in or adjacent to power cord 30 that delivers electrical power to a first electrical device 10, such as project 50, and receiver 22 is positioned within and electrically coupled to a motor that operates a second electrical device 20 comprising either an automatic, electrically retractable projection screen 60 or moveable panels 90 placed substantially adjacent to a projection screen (see FIG. 3A).

According to some embodiments of the invention, the transmission from transmitter 14 to receiver 22 is accomplished via signals sent via a power-line communication technology, as is known in the art; such a communication signal can travel between power receptacles 52 and 54 into L which a first electrical device 10, which can comprise a projector 50 and a second electrical device 20, which can comprise an electrically operated projection screen 60 or moveable panels 90 placed substantially adjacent to a projection screen.

According to some embodiments of the invention, the electrical components of a first electrical device 10 comprise either an automatic, electric, retractable projection screen, as shown in FIG. 3, or one or move moveable panels 90 placed over a projection screen, where the movement of the screen or panels can be accomplished using any technology known in the art. According to some embodiments of the invention, electric motor 62 operates to extend screen 60 or moveable panels 90 located adjacent a projection screen whenever the coupled receiver 64 is receiving an appropriate signal from transmitter 48, such as a signal equating to “on” or “warming-up”; motor 62 further operates to retract screen 60 or moveable panels 90 whenever the coupled receiver 64 no longer receives that signal. According to some embodiments of the invention, electric motor 62 operates to extend screen 60 or moveable panels 90 when receiver 64 receives a single appropriate signal and operates to retract screen 60 or moveable panels 90 when receiver 64 receives a second appropriate signal. The signals received by receiver 64 in this manner may be distinct, as to indicate a selected desired state of screen 60 or moveable panels 90, or the signals may be identical, indicating merely to effect a change in the state of screen 60 or moveable panels 90. Simple circuitry as is known in the art may be used to decode signals received by receiver 64 and provide associated electrical control of screen 60 or moveable panels 90, either based on discrete digital signals, on analog signals, or otherwise.

As described herein, the disclosed system 5 may be used to control any number of different devices, including projection screens that are not retractable, or moveable coverings placed in front of non-moveable projection screens, artwork, or other surfaces. In addition, the disclosed systems and methods may be used to control the position or physical state of innumerable types of second electrical devices 20 based upon the state of a first electrical device 10, where the state of the first electrical device 10 is communicated to a control mechanism, such as an electric motor 62, coupled to the second electrical device 20.

The systems disclosed herein may be manufactured as part of the first and second electrical devices subject to control, so as to include the disclosed features, or the systems may be assembled from existing devices using a variety or technologies.

The identified features, characteristics, functions, and advantages described herein are not meant to be limiting in any way. It is contemplated that one skilled in the art will recognize other apparent features and advantages of the various embodiments of the invention other that those specifically recited, described, or mentioned herein. Therefore, while an embodiment of the invention comprising a projector 50 and projection screen 60 or moveable panels 90 is specifically described, such descriptions are provided with the intention of encompassing like-systems or like-devices or like-methods that may or may not be obvious to one having ordinary skill in the art.

Thus, the present invention may be embodied in other specific forms without departing from its spirit of essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope

What is claimed and desired to be secured by Letters Patent is:

1. A system for controlling the movement of an electrically operated device, comprising
a sensor capable of automatically sensing state information about a second device;
a transmitter coupled to the sensor and capable of transmitting a signal, where the signal is capable of varying between multiple dispositions based substantially upon the state information;
a receiver coupled to the electrically operated device and capable of receiving the signal; and
a means for causing movement in the electrically operated device based upon the disposition of the signal.

2. The system of claim 1 wherein the second device is a visual projection device and the electrically operated device is selected from the group consisting of a retractable projection screen and a moveable covering placed substantially adjacent to a projection screen.

3. The system of claim 2 wherein the state information is a factor selected from the group consisting of the amount of electrical current drawn by the second device, the voltage change apparent within the second device, or the amount of light generated by the second device.

4. The system of claim 2 wherein the signal is communicated to the receiver without the use of a wire connection substantially dedicated to that purpose.

5. The system of claim 2 wherein the visual projection device comprises a power supply cord and the transmitter is located substantially within or adjacent to the power supply cord.

6. The system of claim 2 wherein the sensor is selected from the group consisting of a component that is physically distinct from the visual projection device, and a light-sensitive electrical component placed substantially adjacent to a light source located within the visual projection device.

7. The system of claim 1 wherein the multiple dispositions comprise a disposition indicating a need to change the state of the electrically operated device and a disposition indicating a lack of a need to change the state of the electrically operated device.

8. The system of claim 2 wherein the multiple dispositions comprise a disposition indicating a need to place the electrically operated device in service and a disposition indicating a need to remove the electrically operated device from service.

9. A method for changing the usability state of a projection screen, comprising:
sensing automatically a state of a device, where the device is capable of causing an image to appear on the projection screen;
communicating to a control mechanism associated with the projection screen a signal that varies based upon the state, where the communication is accomplished without the use of a wire connection substantially dedicated to that purpose; and
causing movement in either the projection screen or in materials located substantially adjacent to the projection screen so as to change the usability state.

10. The method of claim 9 wherein the state is a factor selected from the group consisting of the amount of electrical current drawn by the device, the voltage change apparent within the device, and the amount of light generated by the device.

11. The method of claim 9 wherein the state is communicated to the control mechanism using a transmitter located substantially within or adjacent to a power supply cord associated with the device.

12. The method of claim 9 wherein the state is sensed using a sensor that is selected from the group consisting of a component that is physically distinct from the device, and a light-sensitive electrical component placed substantially adjacent to a light source located within the device.

13. A method of manufacturing a system capable of changing the usability state of a projection screen, comprising:
providing a receiver that is coupled to either the projection screen or to materials located substantially adjacent to the projection screen, wherein the receiver is capable of receiving a signal, the signal varies based upon a factor associated with a projection device, and the receiver receives the signal without the use of a wire connection substantially dedicated to that purpose; and
providing a means of causing or controlling movement in one of the group consisting of the projection screen and the materials located substantially adjacent to the projection screen.

14. The method of claim 13 wherein the factor is selected from the group consisting of the amount of electrical current drawn by the projection device, the voltage change apparent within the projection device, and the amount of light generated by the projection device.

15. The method of claim 13 wherein the receiver receives the signal from a transmitter located substantially within or adjacent to a power supply cord associated with the projection device.

16. The method of claim 13 wherein the factor is sensed using a sensor that is selected from the group consisting of a component that is physically distinct from the projection device, and a light-sensitive electrical component placed substantially adjacent to a light source located within the projection device.
